(19) United States
(12) Patent Application Publication
(10) Pub. No.: US 2005/0162415 A1
(43) Pub. Date: Jul. 28, 2005

(54) Intelligent display panel that can adjust its luminosity according to changes in ambient light

(75) Inventors: Wen-Shih Chen, Tainan County (TW); Lai-Wan Liao, Tainan County (TW); Te-Hsiung Lin, Tainan County (TW)

Correspondence Address: REED SMITH LLP, Suite 1400, 3110 Fairview Park Drive, Falls Church, VA, 22042, US

(73) Assignee: Chi Lin Technology Co., Ltd.

(21) Appl. No.: 11/056,158

(22) Filed: Feb. 14, 2005

(30) Foreign Application Priority Data
Jan. 12, 2004 (TW) 093137091

(51) Int. Cl. G09G 5/00

(52) U.S. Cl. 345/207

(57) ABSTRACT

The present invention relates to an intelligent display panel device and method that can adjust its luminosity according to changing ambient light. The device first uses its built-in light detectors to obtain both external and internal luminosity values. A microcomputer system then goes on to compare the values and compute a proper value for adjusting the display panel luminosity. The value is then passed to an internal luminosity converter which first converts the value into a series of signals and then transmits the converted signals to a built-in Luminosity Control Module that will adjust the luminosity of the display panel according to this value. With the present invention, computer users won't have to manually adjust the luminosity of the display panel. The method will compare internal and ambient light and compute an optimum display panel luminosity value in response to changes in the ambient light.

### BACKGROUND OF THE INVENTION

1. Field of the Invention

The present invention relates to a device and method for controlling the luminosity of display panel, particularly a method that can adjust the luminosity of the display panel in response to changing ambient light.

2. Description of the Related Art

Conventional ways of controlling the luminosity of display panels are, generally speaking, some troublesome jobs done by the user himself. By pressing and/or turning a combination of buttons and/or knobs on a display control panel, the user can adjust the luminosity of the display panel and, if luck is with him, chooses a setting that is both good to him and to the display panel. Sometimes, the entire adjustment process is a bit complicate and cumbersome, often leaving the user fumed and frustrated. Besides, users too often unwittingly select a setting that is either two glaring or two dim, not knowing it will hurt the service life of the display panel and/or their eyes.

Another inconvenience and/or peril comes from too frequent adjustment of the display panel, which is often the case when more than one user uses the display panel and constantly changes the luminosity setting to suit his or her own likes, which, in the long run, not only shortens the display panel's service life, but also affects the display quality of the display panel.

The case is the same with notebook computers. A too high luminosity setting not only consumes more power, affects the service life of the display panel, but the glare of the display panel causes the user eye strain and fatigue. On the other hand, although a low luminosity setting saves power and prolongs the service life of the display panel, a display panel too dim not only affects one's working efficiency, but hurts one's eyesight. Also, adjusting luminosity too frequently shortens the service life of the converter inside the display panel, and, sometimes, may even damage the control knobs/buttons, making the display panel inoperable. Some built-in optimum luminosity settings are thus required.

### SUMMARY OF THE INVENTION

In view of the aforementioned problems faced by the prior art, the present invention provides a solution to the problems by introducing an innovative method to produce an intelligent display panel that automatically adjusts its luminosity according to changing ambient light.

The present invention relates to an intelligent display panel that can adjust its luminosity according to changing ambient light. The device first uses a built-in light detector (hereinafter referred to as the Fist Light Detector) located on the outside of the display panel to obtain external ambient light values and another built-in light detector (hereinafter referred to as the Second Light Detector) located inside the display panel to obtain internal luminosity values. A microcomputer then goes on to compare the values and compute a proper value for adjusting the display panel luminosity. The value is then passed to an internal luminosity converter which first converts the value into a series of signals and then transmits the converted signals to a built-in Luminosity Control Module that will adjust the luminosity of the display panel according to this value. In addition, at least one light pipe can be added on the light detectors to boost up the efficiency of photosensitive.

With the present invention, computer users won't have to manually adjust the luminosity of the display panel. The invention will compare internal and ambient light and compute an optimum display panel luminosity value in response to changes in the ambient light.

### BRIEF DESCRIPTION OF THE DRAWINGS

FIG. 1 shows the steps a preferred embodiment of the invention takes to achieve an intelligent control of the display panel's luminosity in relation to the ambient light;

FIG. 2 shows the major components of the device that is a preferred embodiment of the invention;

FIG. 3A shows the luminosity control device of a preferred embodiment of the invention;

FIG. 3B shows the back panel of a preferred embodiment of the invention; and

FIG. 4 shows the light pipe of a preferred embodiment of the invention.

### DETAILED DESCRIPTION OF THE INVENTION

The present invention relates to a device and method for controlling the luminosity of display panels. The invention first uses its built-in at light detectors to obtain both external and internal luminosity values. A microchip system then goes on to compare the values and compute a proper value for adjusting the display panel luminosity. The value is then passed to an internal luminosity converter which first converts the value into a series of signals and then transmits the converted signals to a built-in Luminosity Control Module that will adjust the luminosity of the display panel according to this value. Through the application of this invention, computer users won't have to manually adjust the luminosity of the display panel. The device will compare its internal luminosity with the ambient light and figure out an optimum display panel luminosity adjustment value in response to changes in the ambient light. This will relieve the user of the cumbersome procedures involved in manual adjustment of the settings, and further eliminate the aforementioned hazards that come with too high or too low display panel luminosity.

Before explaining the disclosed embodiment of the present invention in detail it is to be understood that the invention is not limited in its application to the details of the particular arrangement shown here since the invention is capable of other embodiments. Also, the terminology used herein is for the purpose of description and not of limitation

The following is the detailed description of a preferred embodiment of the invention, which will be better understood with the illustrations given hereinafter.

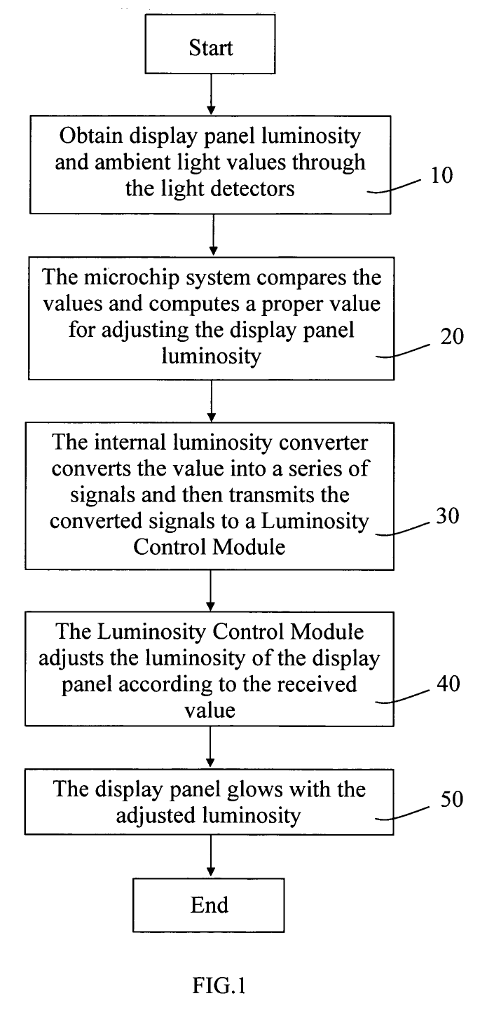

Referring to FIG. 1, FIG. 1 shows how a preferred embodiment of the present invention achieves an intelligent control of the display panel's luminosity in relation to the ambient light. The entire process 1 includes the following steps:

Step 10: Obtain display panel luminosity and ambient light values through the light detectors;

Step 20: The microchip compares the values and computes a proper value for adjusting the display panel luminosity.

Step 30: The internal luminosity converter converts the value into a series of signals and then transmits the converted signals to a Luminosity Control Module

Step 40: The Luminosity Control Module adjusts the luminosity of the display panel according to the received value.

Step 50: The display panel glows with the adjusted luminosity.

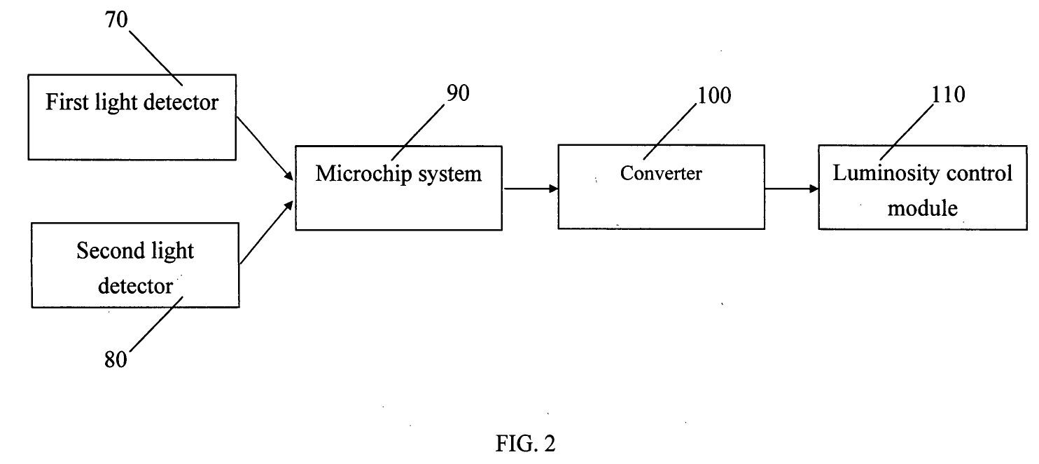

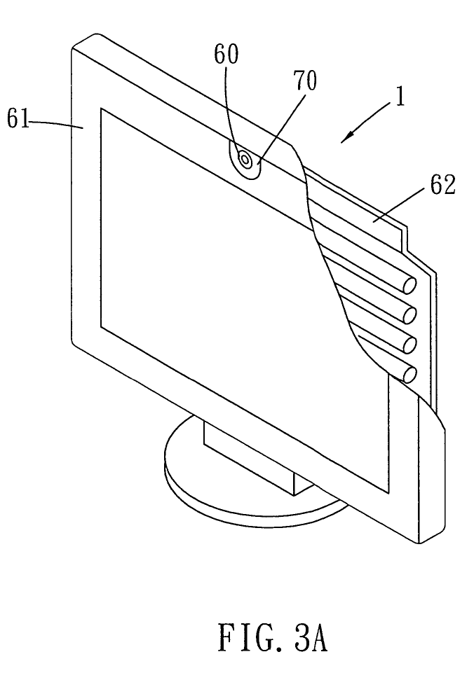

Next, Referring FIG. 2, FIG. 2 shows the major components of the device that is a preferred embodiment of the present invention and the method the device uses to achieve an intelligent control of the display panel's luminosity in response to changes in the ambient light. The components comprise at least one first light detector 70, at least one second light detector 80, a microchip system 90, a converter 100, and a luminosity control module 110. Wherein the first light detector 70 is seated on the outside of the display panel 60, as shown in FIG. 3A, while the second light detector 80, the microchip system 90, the converter 100, and the luminosity control module 110, are built inside the display panel 60.

Also, the at least one first light detector 70 is seated at a proper position on the outside 61 of the display panel 60. To be more specific, the at least one first light detector 70 is seated at a proper position on the upper front 61 of the display panel 60, as shown in FIG. 3A. On the other hand, the at least one second light detector 80 is seated at a proper position inside the back panel 62 of the display panel, as shown in FIG. 3B.

The following is a more specific and detailed description of the steps the preferred embodiment takes to achieve an intelligent control of the display panel's luminosity in relation to the ambient light.

Referring to FIG. 1, we see that when a user is using the display panel 60, the display panel will uses its built-in light detectors to obtain both external and internal luminosity values, as is described in step 10 above. As shown in FIG. 2, FIG. 3A, and FIG. 3B, the at least one first light detector 70 on the upper front 61 of the display panel 60 will collect ambient light values, while the at least one second light detector 80 inside the back panel 62 of the display panel will collect internal luminosity values of the display panel. After the two set of values are collected, the microchip system 90 compares the values and computes a proper value for adjusting the display panel luminosity, as described in step 20 above. The proper value is then converted by the internal luminosity converter into a series of signals and then transmitted to the Luminosity Control Module 110, as described in step 30 above. The Luminosity Control Module 110 then adjusts the luminosity of the display panel, by raising or lowering the luminosity of its internal CCFT (cold cathode fluorescent tubes), according to the received value, as described in step 40 above. Now, the display panel glows with the adjusted luminosity, as described in step 50 above. When the ambient light changes, the entire process comprising the above steps will be repeated.

To be more specific, the mode in which the intelligent display panel adjusts its luminosity is as follows:

1. When the ambient light is brighter than the display panel's internal luminosity, the microchip system in the display panel will, after the comparison and computing step, raise the internal luminosity of the display panel.

2. When the ambient light is darker or dimmer than the display panel's internal luminosity, the microchip system in the display panel will, after comparison and computing step, lower the internal luminosity of the display panel.

According to different ambient light, the microchip system will operate and compare the values obtaining from light detectors to get an internal luminosity adjustment value. When the internal luminosity values to be adjust to the internal luminosity adjustment value, the internal luminosity adjustment value might have a value which might higher than, equal to, or lower than the external light value.

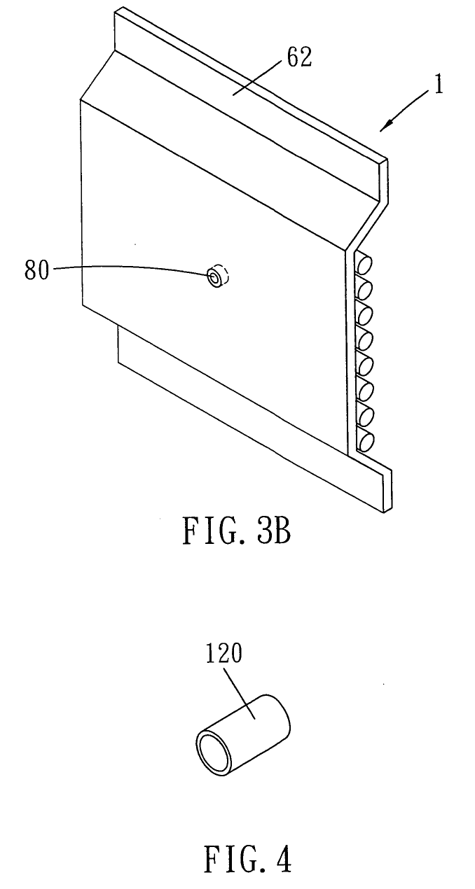

Also, as shown in FIG. 4, an (optional) light pipe 120 can be installed on the fist light detector 70 and the second light detector 80, respectively, to boost up the efficiency of photosensitive of each so that more accurate internal and external luminosity values can be obtained.

Of course, although the invention relates to an intelligent display panel that can automatically adjust its luminosity according to changing ambient light—an improvement when compared with the more traditional way of manual luminosity adjustment, the improvement shall by no means be interpreted as a limitation, but, rather, as an added feature. Any preferred embodiment of the invention will still include those features that allow the user to manually adjust screen luminosity.

Also, the microchip system used in the invention to control display panel luminosity is a microchip module which comprises a ROM (Read Only Memory) and a programmable Flash memory that can be used to store commands given by the user. When the microchip system receives the luminosity values sent by the internal luminosity detector and the ambient light detector, it will compare the two set of values and compute an internal luminosity adjustment value.

From the above description and illustration, it is obvious that the intelligent display panel possesses the following features and enjoys the following advantages over conventional type display panels:

1. As the invention is an intelligent device that automatically adjust the best luminosity setting for the user, the user is relieved of the cumbersome and repeating job of manually choosing the setting in response to the frequent changes in ambient light. This is truly a great convenience to the user.

2. Different users will have the same optimum setting to follow without having to re-adjust the settings according to their own likes. This in the long run prolongs the service life of display panel and greatly saves cost in terms of maintenance.

3. The invention's automatic intelligent adjustment of luminosity setting greatly reduces the possibility of overuse and/or misuse of the display panel, effectively extending its service life.

As is understood by a person skilled in the art, the foregoing preferred embodiment of the present invention is an illustration, rather than a limiting description, of the present invention. It is intended to cover various modifications and similar arrangements included within the spirit and scope of the appended claims, the scope of which should be accorded the broadest interpretation so as to encompass all such modifications and similar structures.

1. A luminosity control device, to be used in an intelligent display panel, which can adjust a display panel's internal luminosity according to changing ambient light;
said device comprises:
a display panel, comprising a front panel and a back panel;
at least one first light detector, seated at a proper position on the outside of the display panel;
at least one second light detector, placed at a proper position inside the display panel;
a microchip system, placed at a proper position inside the display panel;
a converter, placed at a proper position inside the display panel; and
a luminosity control module, placed at a proper position inside the display panel.

2. A luminosity control device to be used in an intelligent display panel as described in claim 1, wherein said display panel is a liquid crystal display.

3. A luminosity control device to be used in an intelligent display panel as described in claim 1, wherein said display panel is a notebook PC's display.

4. A luminosity control device to be used in an intelligent display panel as described in claim 1, wherein said microchip system is a microchip module.

5. A luminosity control device to be used in an intelligent display panel as described in claim 1, wherein said first light detector is seated at a proper position on the upper front outside of said display panel.

6. A luminosity control device to be used in an intelligent display panel as described in claim 1, wherein said first light detector further comprises a light pipe.

7. A luminosity control device to be used in an intelligent display panel as described in claim 1, wherein said second light detector further comprises a light pipe.

8. A luminosity control device to be used in an intelligent display panel as described in claim 6, wherein said light pipe is shaped like a circular pipe.

9. A luminosity control device to be used in an intelligent display panel as described in claim 7, wherein said light pipe is shaped like a circular pipe.

10. A luminosity control method to be used in an intelligent display panel that can adjust its luminosity in response to changing ambient light; said method comprises the following steps:
providing an external luminosity value—using said first light detector to obtain ambient light value.
providing an internal luminosity value—using said second light detector to obtain luminosity value inside said display panel.
providing an internal luminosity adjustment value—using said microchip system to compare the external luminosity value with the internal luminosity value and compute a proper value for adjusting the display panel luminosity.
converting the value into a series of signals—using said converter to converts the value into a series of signals and then transmits the converted signals to a Luminosity Control Module.
setting the internal luminosity level according to the value received by said Luminosity Control Module.

11. A luminosity control method to be used in an intelligent display panel as described in claim 10, when said external luminosity value is detected to be higher than said internal luminosity value, said internal luminosity value is raised to equal the internal luminosity adjustment value.

12. A luminosity control method to be used in an intelligent display panel as described in claim 10, when said external luminosity value is detected to be lower than said internal luminosity value, said internal luminosity value is lowered to equal the internal luminosity adjustment value.

13. A luminosity control method to be used in an intelligent display panel as described in claim 11, wherein said internal luminosity adjustment value is higher than the external luminosity.

14. A luminosity control method to be used in an intelligent display panel as described in claim 11, wherein said internal luminosity adjustment value is equal to the internal luminosity value.

15. A luminosity control method to be used in an intelligent display panel as described in claim 12, wherein said internal luminosity adjustment value is lower than the internal luminosity value.

16. A luminosity control method to be used in an intelligent display panel as described in claim 12, wherein said internal luminosity adjustment value is equal to the internal luminosity value.
